(19) United States
(12) Patent Application Publication
(10) Pub. No.: US 2025/0223457 A1
(43) Pub. Date: Jul. 10, 2025

(54) Dye Printing Treatment Liquid Composition, Composition Set, Printing Method, And Ink Jet Printing Method

(71) Applicant: SEIKO EPSON CORPORATION, Tokyo (JP)

(72) Inventors: Toshiaki OGUCHI, Okaya (JP); Kazuki SHIMURA, Yamagata (JP); Yuta ASAKAWA, Azumino (JP)

(21) Appl. No.: 19/014,427

(22) Filed: Jan. 9, 2025

(30) Foreign Application Priority Data
Jan. 10, 2024 (JP) 2024-001762
Apr. 3, 2024 (JP) 2024-059886

(51) Int. Cl. C09D 11/54; B41J 3/407; C09D 11/102; C09D 11/40; D06P 1/52; D06P 1/54; D06P 5/00; D06P 5/24; D06P 5/30

(52) U.S. Cl. CPC C09D 11/54; C09D 11/102; C09D 11/40; D06P 1/5285; D06P 1/54; D06P 5/002; D06P 5/003; D06P 5/30; B41J 3/4078

(57) ABSTRACT

A dye printing treatment liquid composition of the present disclosure is used to be adhered to a cloth and contains resin particles, a thickener, and water. The dye printing treatment liquid composition has a viscosity of 3.0 mPa·s or more at 20° C., and a total concentration of potassium ions and sodium ions detected from the treatment liquid composition by an ion chromatographic method is 100.0 ppm or less.

The present application is based on, and claims priority from JP Application Serial Number 2024-001762, filed Jan. 10, 2024 and JP Application Serial Number 2024-059886, filed Apr. 3, 2024, the disclosures of which are hereby incorporated by reference herein in their entirety.

### BACKGROUND

### 1. Technical Field

The present disclosure relates to a dye printing treatment liquid composition, a composition set, a printing method, and an ink jet printing method.

### 2. Related Art

Heretofore, when a printed matter is manufactured by dyeing a cloth with a colorant, in order to improve a color development property and texture characteristics of the colorant, a technique in which a cloth is pre-treated using a treatment liquid has been known. As the technique as described above, for example, JP-A-2019-90149 has disclosed a printing pre-treatment agent containing at least polyester resin particles and an urethane resin emulsion.

However, according to the printing pre-treatment agent disclosed in JP-A-2019-90149, when a treatment liquid composition is adhered to a cloth, and the cloth to which the treatment liquid composition is adhered is dye-printed, after the dye printing is performed, a problem in that pre-treatment marks unfavorably remain on the dye-printed cloth may arise. In addition, by the printing pre-treatment agent described above, a problem in that a printed matter excellent in color development property and texture characteristics is difficult to obtain may also occur.

### SUMMARY

According to an aspect of the present disclosure, there is provided a dye printing treatment liquid composition which is used to be adhered to a cloth and which comprises resin particles, a thickener, and water. The dye printing treatment liquid composition described above has a viscosity of 3.0 mPa·s or more at 20° C., and a total concentration of potassium ions and sodium ions detected from the treatment liquid composition by an ion chromatographic method is 100.0 ppm or less.

### BRIEF DESCRIPTION OF THE DRAWINGS

FIG. 1 is a flowchart showing one example of an indirect printing recording method of this embodiment.

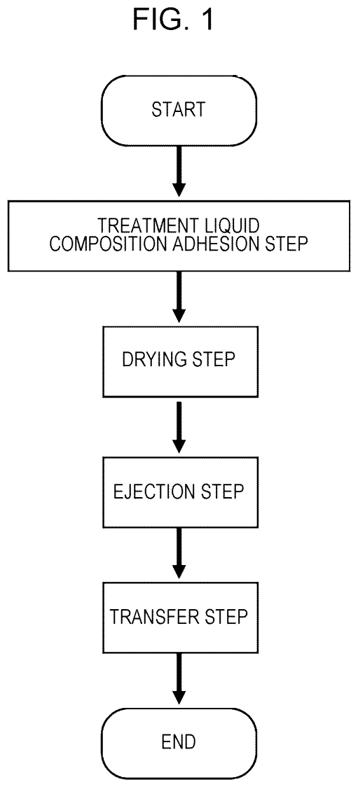

FIG. 2 is Table 1 showing compositions of treatment liquid compositions.

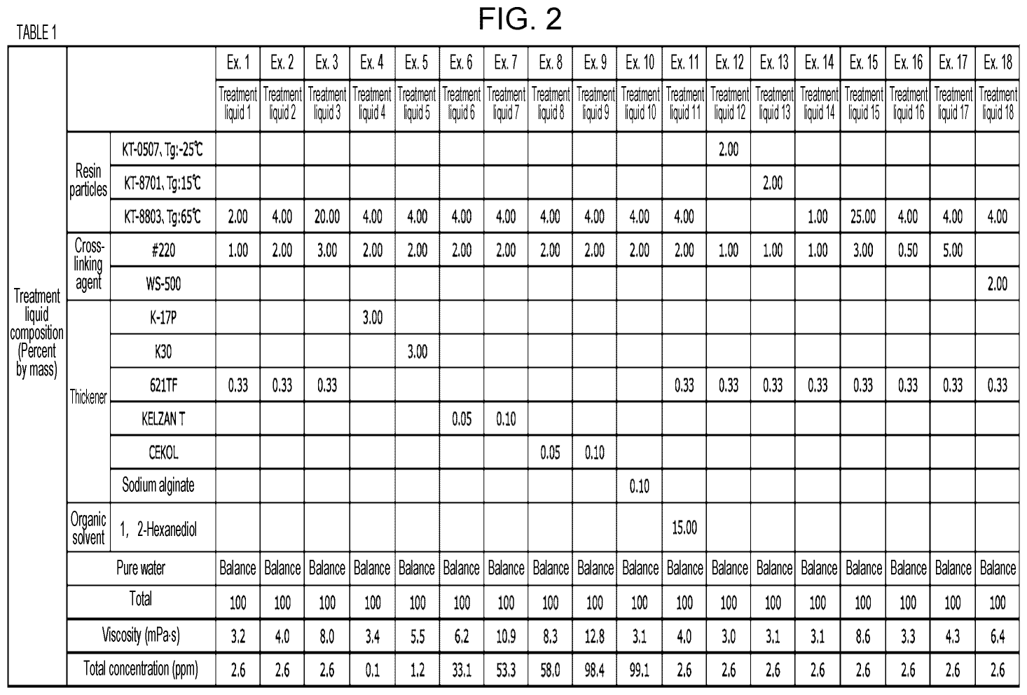

FIG. 3 is Table 2 showing compositions of treatment liquid compositions.

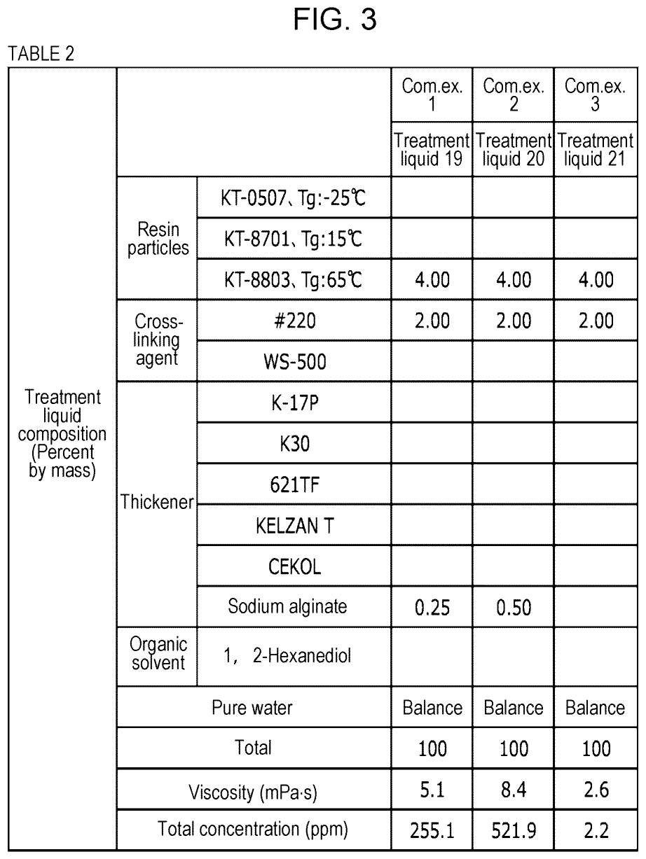

FIG. 4 is Table 3 showing a composition of an ink jet ink composition.

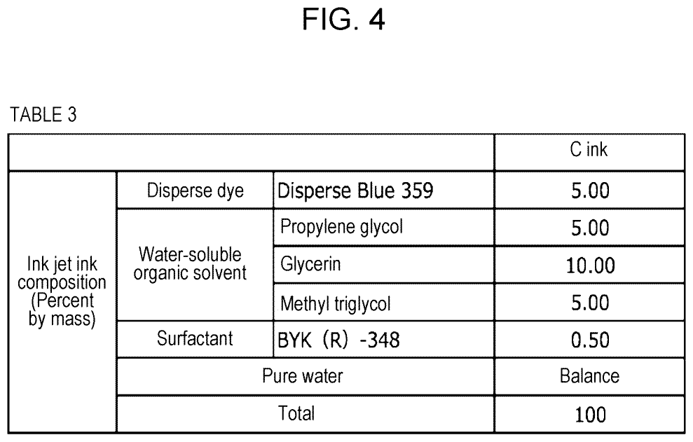

FIG. 5 is Table 4 showing evaluation results.

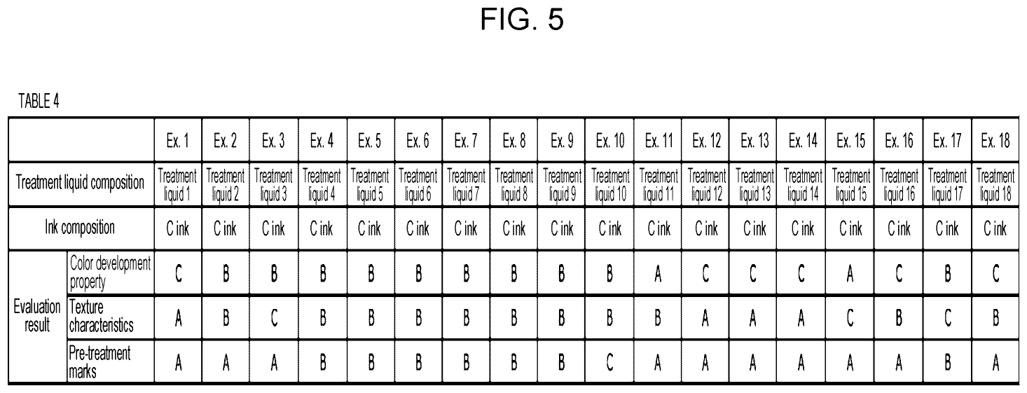

FIG. 6 is Table 5 showing evaluation results.

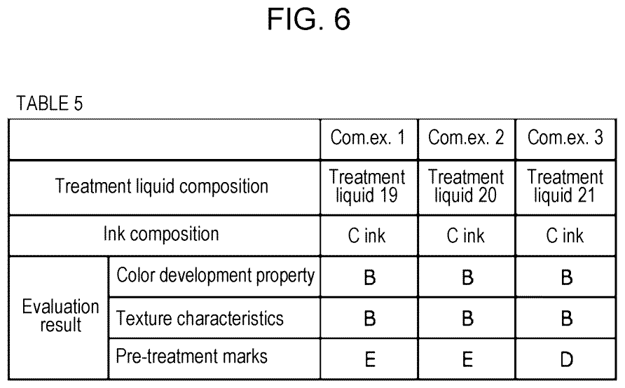

### DESCRIPTION OF EMBODIMENTS

Hereinafter, although embodiments (hereinafter, each referred to as “this embodiment”) of the present disclosure will be described in detail, the present disclosure is not at all limited thereto and may be variously changed and/or modified without departing from the scope of the present disclosure.

### 1. Dye Printing Treatment Liquid Composition

A dye printing treatment liquid composition (hereinafter, also referred to as “treatment liquid composition” in some cases) of this embodiment is a treatment liquid composition which is used to be adhered to a cloth, which contains resin particles, a thickener, and water, and which has a viscosity of 3.0 mPa·s or more at 20° C., and a total concentration of potassium ions and sodium ions detected from the treatment liquid composition by an ion chromatographic method is 100.0 ppm or less. Before the cloth is dye-printed, the treatment liquid composition is preferably used to be adhered thereto.

According to this embodiment, even when the treatment liquid composition is adhered to a cloth in advance, and the cloth to which the treatment liquid composition is adhered is dye-printed, pre-treatment marks are unlikely to remain on the dye-printed cloth, and in addition, a printed matter excellent in color development property and texture characteristics can be obtained.

Although the reason the excellent effect as described above is obtained by this embodiment has not been clearly explained, the present inventors assume as follows.

That is, in general, since a cloth is manufactured using components, such as a surfactant and a paste, those components approximately uniformly remain all over the cloth. As a result, when the treatment liquid composition is adhered to the cloth and is then dried, in association with this drying, those components are transferred in the cloth and are localized. The components thus localized may generate pre-treatment marks on the cloth surface in some cases.

However, the treatment liquid composition of this embodiment contains resin particles, a thickener, and water and has a viscosity of 3.0 mPa·s or more at 20° C., and a total concentration of potassium ions and sodium ions detected from the treatment liquid composition by an ion chromatographic method is 100.0 ppm or less. Since the viscosity of the treatment liquid composition is 3.0 mPa·s or more at 20° C., the transfer rates of the components, such as a surfactant and a paste, in the cloth can be more decreased. Hence, in the cloth, the localization caused by the components described above is suppressed, and the generation thereof in the form of pre-treatment marks can be preferably suppressed.

In addition, although the thickener is contained in the treatment liquid composition for viscosity adjustment or the like, the thickener may contain potassium ions and sodium ions in some cases. When a treatment liquid composition containing the thickener as described above is used as a pre-treatment agent for the cloth, in the cloth, those ions react with carbon dioxide in the air to generate a potassium carbonate salt and a sodium carbonate salt. In the case described above, those carbonate salts may appear in the form of pre-treatment marks on the cloth surface in some cases. However, in the treatment liquid composition of this embodiment, the total concentration of potassium ions and sodium ions detected therefrom by an ion chromatographic method is 100.0 ppm or less. Accordingly, in the cloth, those carbonate salts are unlikely to be generated, and the pre-treatment marks derived from the carbonate salts are unlikely to appear.

In addition, since the treatment liquid composition contains the resin particles, a dye dissolved in an organic solvent is also able to dye the resin particles, and the resin particles thus dyed are allowed to be appropriately present in the cloth. By the reason as described above, since the dye printing is performed after the treatment liquid composition of this embodiment is adhered to the cloth, while appropriate texture characteristics are maintained, a large amount of ink can be adhered to the vicinity of the cloth.

Accordingly, it is assumed that when the treatment liquid composition is used, the pre-treatment marks are unlikely to remain on the dye-printed cloth, and in addition, a printed matter excellent in color development property and texture characteristics can be obtained. However, the reason is not limited to that described above.

Next, physical properties of the treatment liquid composition and an ink composition, components contained therein, an application method of the treatment liquid composition, and the like will be described. First of all, the physical properties of the treatment liquid composition will be described.

### 1.1. Physical Properties of Treatment Liquid Composition

The physical properties of the treatment liquid composition are arbitrarily adjusted, for example, by types of cloths and adhesion methods to cloths, that is, application methods.

### 1.1.1. Viscosity

A viscosity of the treatment liquid composition at 20° C. is 3.0 mPa·s or more.

When a treatment liquid composition having a viscosity in the range described above is used for the cloth, the transfer rates of components, such as a surfactant and a paste, in the cloth can be more decreased. Hence, in the cloth, the localization caused by the components described above is suppressed, and the generation of pre-treatment marks on the cloth surface can be preferably suppressed. In addition, when the treatment liquid composition is adhered to the cloth, coatability, such as spreadability, of the treatment liquid composition, can also be improved.

The viscosity of the treatment liquid composition is measured using a viscoelastic measurement apparatus. In particular, when the temperature of the treatment liquid composition is adjusted at 20° C., and a shear viscosity (mPa·s) at a shear rate of 200 sec-1 is read, the viscosity can be measured. A more specific measurement method may be performed with reference to that described in Example.

The viscosity of the treatment liquid composition at 20° C. is preferably 3.0 to 15.0 mPa·s and more preferably 3.0 to 13.0 mPa·s. When a treatment liquid composition having a viscosity in the range described above is used for the cloth, the generation of pre-treatment marks on the cloth surface can be more preferably suppressed.

### 1.1.2. Total Concentration

In the treatment liquid composition, the total concentration of potassium ions and sodium ions (hereinafter, simply referred to as the “total concentration” in some cases) detected therefrom by an ion chromatographic method is 100.0 ppm or less.

When a treatment liquid composition having a total concentration in the range described above is used for the cloth, in the cloth, a potassium carbonate salt and a sodium carbonate salt are unlikely to be generated, and the generation of pre-treatment marks derived from the carbonate salts can be preferably suppressed on the cloth surface.

The total concentration is measured by an ion chromatographic method. In particular, first of all, after 20 g of the treatment liquid composition is processed by a centrifugal filtration method at a revolution rate of 8,000 rpm for 5 minutes, a solid-liquid separation using a syringe filter having a size of 0.2 μm is performed, and a supernatant solution is recovered. Subsequently, the supernatant solution is diluted with pure water, so that a 100-times diluted solution is prepared. The solution thus prepared is measured using an ion chromatographic method, and by using a calibration curve prepared in advance, the total concentration (ppm) of potassium ions and sodium ions detected from the treatment liquid composition is calculated. A more particular measurement method may be performed with reference to that described in Example.

The total concentration is preferably 60.0 ppm or less, more preferably 30.0 ppm or less, even more preferably 10.0 ppm or less, and further preferably 5.0 ppm or less. When a treatment liquid composition having a total concentration in the range described above is used for the cloth, the generation of pre-treatment marks on the cloth surface can be more preferably suppressed. Although a lower limit of the total concentration is not particularly limited, for example, in consideration of the quantification limit of an ion chromatographic method, in general, the lower limit is 1.0 ppm or more. In addition, the lower limit of the total concentration may also be 0.0 ppm.

### 1.1.3. Surface Tension

A surface tension of the treatment liquid composition at 25° C. is preferably 30 to 50 mN/m. When the surface tension of the treatment liquid composition at 25° C. is set in the range described above, appropriate wettability and permeability to the cloth can be obtained. In addition, since the treatment liquid composition is likely to be uniformly absorbed in the cloth, a concentration difference in adhesion amount generated when the treatment liquid composition is applied, that is, the generation of application irregularity, can be suppressed.

In addition, the surface tension of the treatment liquid composition can be measured, for example, using an automatic surface tension meter CBVP-Z (manufactured by Kyowa Interface Science Co., Ltd.). In particular, in an environment at 25° C., a surface tension obtained when a platinum plate is wetted with the treatment liquid composition is read, so that the surface tension thereof can be measured.

### 1.2. Resin Particles

The treatment liquid composition contains resin particles.

Since the treatment liquid composition contains resin particles, the pre-treatment marks are unlikely to remain on the dye-printed cloth, and in addition, a printed matter excellent in color development property and texture characteristics can be obtained.

As the resin particles, for example, there may be mentioned a polyester-based resin, an urethane-based resin, an addition polymerization type resin, a fluorine resin, and a natural resin. Although being frequently handled in the form of emulsion, that is, in the form of resin dispersion, those resin particles may also be supplied in the form of powder. As the resin particles, one type thereof may be used alone, or at least two types thereof may be used in combination.

Since the pre-treatment marks are unlikely to remain on the dye-printed cloth, and a printed matter more excellent in color development property and texture characteristics tends to be obtained, as the resin particles, at least one selected from the group consisting of a polyester-based resin and an urethane-based resin is preferably contained, and a polyester-based resin is more preferably contained.

Since the pre-treatment marks are unlikely to remain, and a printed matter having not only excellent texture characteristics but also a more excellent color development property tends to be obtained, a glass transition temperature of the polyester-based resin is preferably −25° C. or more, more preferably 1° C. or more, even more preferably 15° C. or more, and further preferably 25° C. or more. An upper limit of the glass transition temperature may be, for example, 180° C. or less or 150° C. or less. In addition, in this specification, the glass transition temperature of the polyester-based resin can be measured, for example, by a differential scanning calorimetry (hereinafter, also referred to as “DSC” in some cases).

As the polyester-based resin, for example, a resin having a structural unit derived from a polyvalent carboxylic acid and a structural unit derived from a polyvalent alcohol may be mentioned.

As the polycarboxylic acid, for example, there may be mentioned a phthalic acid, such as terephthalic acid, isophthalic acid, or ortho-phthalic acid, 4,4′-diphenyldicarboxylic acid, 2,5-naphhtalene dicarboxylic acid, 1,5-naphhtalene dicarboxylic acid, 2,6-naphhtalene dicarboxylic acid, 2,7-naphhtalene dicarboxylic acid, 1,4-cyclohexane dicarboxylic acid, 2-potassium sulfoterephthalic acid, 5-sodium sulfoisophthalic acid, adipic acid, azelaic acid, sebacic acid, dodecane dicarboxylic acid, glutaric acid, succinic acid, trimellitic acid, trimesic acid, pyromellitic acid, trimellitic anhydride, phthalic anhydride, succinic anhydride, or p-hydroxy benzoic acid, or at least one of salts thereof. As the salt, for example, a potassium salt, a sodium salt, a calcium salt, or a magnesium salt may be mentioned.

As the polyvalent alcohol, for example, there may be mentioned ethylene glycol, 1,2-propylene glycol, 1,3-propylene glycol, 1,3-propanediol, 1,3-butylene glycol, 1,4-butanediol, 1,6-hexanediol, 2-methyl-1,5-pentanediol, neopentyl glycol, 1,4-cyclohexanedimethanol, p-xylylene glycol, a bisphenol A-ethylene glycol adduct, diethylene glycol, triethylene glycol, a polyethylene glycol, a polypropylene glycol, a polytetramethylene glycol, a polytetramethyleneoxide glycol, dimethylol propionic acid, glycerin, trimethylolpropane, sodium dimethylol ethyl sulfonate, potassium dimethylol ethyl sulfonate, or potassium dimethylol propionate.

The polyester-based resin preferably includes a hydroxy group, a carboxy group, and a sulfonic acid group, and salts thereof. In the polyester-based resin, at least one of those groups described above may be included.

A sulfonic acid group-containing polyester-based resin has, for example, a structural unit derived from a polyvalent carboxylic acid, a structural unit derived from a polyvalent alcohol, and a structural unit derived from a sulfonic acid group-containing aromatic monomer.

As the sulfonic acid group-containing aromatic monomer, for example, there may be mentioned 5-sulfoisophthalic acid, sulfoterephthalic acid, 4-sulfophthalic acid, 4-sulfonaphthalene-2,7-dicarboxylic acid, or 4-sulfo-1,8-naphhtalene dicarboxylic anhydride, or a salt thereof. As the salt, one of the above salts may be mentioned as reference, and a sodium salt is preferable.

Since containing those groups, the polyester-based resin can react with a cross-linking agent and preferably with an isocyanate group-containing compound, and a binding property with the cloth and preferably with a cloth containing fibers having hydroxy groups tends to be improved. Hence, the pre-treatment marks are unlikely to remain, and a printed matter having not only excellent texture characteristics but also a more excellent color development property tends to be obtained.

The polyester-based resin can be obtained, for example, using a normal polycondensation reaction by appropriately selecting a least one of the polycarboxylic acids, a least one of the polyalcohols, and if needed, at least one of the sulfonic acid group-containing aromatic monomers.

As the polyester-based resin as described above, a commercial product may also be used. As the commercial product, for example, there may be mentioned Elitel (registered trademark) KA-5071s, KT-8803, KT-9204, KT-8701, KT-8904, or KT-0507 (trade name, manufactured by Unitika Ltd., polyester resin emulsion); Hitec (registered trademark) SN-2002 (trade name, manufactured by Toho Chemical Industry Co., Ltd., polyester resin emulsion); Plascoat (registered trademark) Z-221, Z-446, Z-561, Z-565, RZ-570, Z-592, Z-687, Z-690, Z-730, Z-760, RZ-105, RZ-570, or RZ-760 (trade name, manufactured by Goo Chemical Co., Ltd.); or Bironal (registered trademark) MD-1200, MD-1500, or MD-2000 (trade name, manufactured by Toyobo Co., Ltd.).

The urethane-based resin is a generic name of a resin having an urethane bond. As the urethane-based resin, for example, there may be mentioned a polyether type urethane resin having an ether bond in its main chain besides an urethane bond, a polyester type urethane resin having an ester bond in its main chain besides an urethane bond, or a polycarbonate type urethane resin having a carbonate bond in its main chain besides an urethane bond. In addition, as the urethane-based resin, a commercial product may also be used. For example, there may be mentioned Superflex (registered trademark) 460, 460s, 840, or E-4000 (trade name, manufactured by DKS Co., Ltd.), Resamine (registered trademark) D-1060, D-2020, D-4080, D-4200, D-6300, or D-6455 (trade name, Dainichiseika Color & Chemicals Mfg. Co., Ltd.), Takelac (registered trademark) W-6061, WS-6021, or W-512-A-6 (trade name, manufactured by Mitsui Chemicals Polyurethanes, Inc.), Suncure (registered trademark) 2710 (trade name, manufactured by Lubrizol), or Permarine (registered trademark) UA-150 (trade name, manufactured by Sanyo Chemical Industries, Ltd.).

As the addition polymerization type resin, for example, there may be mentioned a homopolymer or a copolymer each using (meth)acrylic acid, a (meth)acrylate ester, acrylonitrile, cyanoacrylate, acrylamide, an olefin, styrene, a silicone, a rosin, a terpene, an epoxy, an ester, vinyl acetate, vinyl chloride, vinyl alcohol, vinyl ether, vinyl pyrrolidone, vinyl pyridine, vinyl carbazole, vinyl imidazole, or vinylidene chloride.

As other commercial products each in the form of emulsion, for example, there may be mentioned VINYBLAN (registered trademark) 150, 603, 745, or 1245L (trade name, manufactured by Nissin Chemical Industry Co., Ltd.); DANFIX (registered trademark) MM11 (trade name, manufactured by Nissin Chemical Industry Co., Ltd.); SENKAANTIFRIC (registered trademark) CX-2 (trade name, manufactured by Senka Corporation); Movinyl (registered trademark) 966A (trade name, manufactured by Nippon Synthetic Chemical Industry Co., Ltd.); Microgel (registered trademark) E-1002 or E-5002 (trade name, manufactured by Nippon Paint Co., Ltd.); Boncoat (registered trademark) 4001 or 5454 (trade name, manufactured by DIC Corporation); SAE1014 (manufactured by Zeon Corporation); Saivinol (registered trademark) SK-200 (trade name, manufactured by Saiden Chemical Industry Co., Ltd.); Joncryl (registered trademark) 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (trade name, manufactured by BASF); NK Binder R-5HN (trade name, manufactured by Shin-Nakamura Chemical Co., Ltd.); Suncure 2710 (trade name, manufactured by Nippon Lubrizol); Permarin (registered trademark) UA-150 (trade name, manufactured by Sanyo Chemical Industries, Ltd.); Superflex (registered trademark) 460, 470, 610, or 700 (trade name, manufactured by DKS Co., Ltd.); NeoRez (registered trademark) R-9660, R-9637, or R-940 (trade name, manufactured by Kusumoto Chemicals, Ltd.); Adeka Bontigher (registered trademark) HUX-380 or 290K (trade name, manufactured by ADEKA Corporation); or Takelac (registered trademark) W-605, w-635, or Ws-6021 (trade name, manufactured by Mitsui Chemicals, Inc.).

In addition, although the commercial products are mentioned above, the resin particles may be synthesized using a general method.

Since the pre-treatment marks are more unlikely to remain, and a printed matter more excellent in color development property and texture characteristics tends to be obtained, a content of the resin particles with respect to a total mass of the treatment liquid composition is preferably 1.0 to 25.0 percent by mass on a solid content basis. Since the pre-treatment marks are more unlikely to remain, and a printed matter having not only more excellent texture characteristics but also a further excellent color development property tends to be obtained, the content of the resin particles with respect to the total mass of the treatment liquid composition is more preferably 4.0 to 25.0 percent by mass on a solid content basis. Since the pre-treatment marks are more unlikely to remain, and a printed matter further excellent in color development property and texture characteristics tends to be obtained, the content of the resin particles with respect to the total mass of the treatment liquid composition is further preferably 3.0 to 15.0 percent by mass on a solid content basis.

### 1.3. Thickener

The treatment liquid composition contains a thickener.

Since the treatment liquid composition contains a thickener, the pre-treatment marks are unlikely to remain on the dye-printed cloth, and in addition, a printed matter excellent in color development property and texture characteristics can be obtained. The thickener may be used alone, or at least two types thereof may be used in combination.

In this specification, the thickener is a material capable of adjusting the viscosity of the treatment liquid composition and is preferably a material to increase the viscosity.

As the thickener, for example, there may be mentioned a vegetable-based high molecular weight material, such as gum arabic, tragacanth, galactan, carob gum, guar gum, karaya gum, carrageenan, pectin, agar, quince seed, algae colloid, tranto gum, glucomannan, dextrin, cyclodextrin, tamarind gum, funori (dried seaweed), pectic acid, shiratsu gum, or locust bean gum; a microbial high molecular weight material, such as xanthan gum, dextran, succinoglucan, or pullulan; an animal-based high molecular weight material, such as collagen, casein, albumin, glue, or gelatin; a starch-based high molecular weight material, such as starch, roasted starch, alpha starch, oxidized starch, carboxy starch, carboxymethyl starch, carboxyethyl starch, hydroxyethyl starch, dialdehyde starch, or methyl hydroxypropyl starch; a cellulose-based high molecular weight material, such as cellulose, methylcellulose, ethylcellulose, methyl hydroxypropyl cellulose, carboxy methyl cellulose, hydroxy methyl cellulose, hydroxy ethyl cellulose, hydroxy propyl cellulose, hydroxypropyl methyl cellulose, nitrocellulose, cellulose sodium sulfate, sodium carboxy methyl cellulose, crystalline cellulose, cationized cellulose, or cellulose powder; an alginic acid-based high molecular weight material, such as sodium alginate, potassium alginate, ammonium alginate, or alginic acid propylene glycol ester; a vinyl-based high molecular weight material, such as poly(vinyl pyrrolidone), poly(vinyl alcohol), poly(vinyl formal), poly(vinyl methyl ether), or carboxy vinyl polymer; a poly(oxyalkylene)-based high molecular weight material, such as poly(oxyethylene)-based polymer or poly(oxyethylene) poly(oxypropylene) copolymer; an acrylic-based high molecular weight material, such as modified polyacrylic acid, modified polyacrylic acid emulsion, sodium polyacrylate, polyethylene acrylate, polyacrylamide, or acryloyldimethyltaurate salt copolymer; a methacrylic-based high molecular weight material, such as modified polymethacrylic acid, modified polymethacrylic acid emulsion, sodium polymethacrylate, poly(ethyl methacrylate), polymethacrylamide, or methacryloyldimethyltaurate salt copolymer; a synthetic water-soluble high molecular weight material, such as urethane modified polyether, poly(ethylene imine), or cationic polymer; or inorganic-based water-soluble high molecular weight material, such as bentonite, aluminum magnesium silicate, montmorillonite, beidellite, nontronite, saponite, hectorite, or silicic anhydride. Since the pre-treatment marks are more unlikely to remain, and a printed matter more excellent in color development property and texture characteristics tends to be obtained, as the thickener, at least one selected from the group consisting of microbial high molecular weight materials, cellulose-based high molecular weight materials, alginic acid-based high molecular weight materials, vinyl-based high molecular weight materials, and synthetic water-soluble high molecular weight materials is preferably contained, and at least one selected from the group consisting of xanthan gum, carboxy methyl cellulose, sodium alginate, poly(vinyl pyrrolidone), and urethane modified polyether is more preferably contained.

As the thickener as described above, a commercial product may also be used. As the commercial product, for example, there may be mentioned SOKALAN (registered trademark) K-17P, K-30P, K-60P, K-80P, K-85P, K-90P, or K-115P (trade name, manufactured by BASF SE, poly(vinyl pyrrolidone); PITZCOL (registered trademark) K-30, K-50, K-80, K-85, K-90, K-17L, K-30L, K-30AL, K-60L, K-90L, or K-120L (trade name, DKS Co., Ltd., poly(vinyl pyrrolidone); CREEJUS (registered trademark) K-30 or K-90 (trade name, DKS Co., Ltd., poly(vinyl pyrrolidone); SN Thickener 621TF (trade name, manufactured by San Nopco Ltd., urethane modified polyether); SN Thickener 929 (trade name, manufactured by San Nopco Ltd., sodium polycarboxylic acid); SN Thickener 630 or 920 (trade name, manufactured by San Nopco Ltd., modified polyacrylic acid emulsion); SN Thickener 617 (trade name, manufactured by San Nopco Ltd., modified polyacrylic acid); Vistool (registered trademark) 3015 (trade name, manufactured by San Nopco Ltd., modified polyacrylic acid); KELZAN (registered trademark) T, S, AR, RD, ST, M, HP, or ASX (trade name, manufactured by Sansho Co., Ltd., xanthan gum), Eco Gum (registered trademark) or Monart Gum (registered trademark) GS (trade name, manufactured by Sumitomo Pharma Co., Ltd., xanthan gum), CEKOL (registered trademark) 150, 700, or 30000 (carboxy methyl cellulose) (trade name, manufactured by Sansho Co., Ltd.).

Since the pre-treatment marks are more unlikely to remain, and a printed matter more excellent in color development property and texture characteristics tends to be obtained, a content of the thickener with respect to the total mass of the treatment liquid composition on a solid content basis is preferably 0.01 to 10.0 percent by mass, more preferably 0.02 to 7.0 percent by mass, and further preferably 0.03 to 5.0 percent by mass.

### 1.4. Water

The treatment liquid composition contains water.

After the treatment liquid composition is adhered to the cloth, the water is evaporated and scattered by drying. As the water, for example, there may be mentioned pure water, such as ion exchange water, ultrafiltration water, reverse osmosis water, or distilled water, or water, such as ultrapure water, in which ionic impurities are removed as much as possible. In addition, when the treatment liquid composition is stored for a long time, water sterilized by UV radiation, addition of hydrogen peroxide, or the like is preferable since generation of fungi and bacteria can be suppressed.

A content of the water in the treatment liquid composition with respect to the total mass of the treatment liquid composition is preferably 30.0 to 99.0 percent by mass and more preferably 35.0 to 98.0 percent by mass. Since the content of the water is set in the range described above, while the viscosity of the treatment liquid composition is suppressed from being increased, workability when the treatment liquid composition is adhered to the cloth and the drying property after the adhesion of the treatment liquid composition can be improved.

Since a higher affinity and a higher safety can be imparted to the cloth and preferably to a cloth containing fibers having hydroxy groups, the treatment liquid composition is preferably a water-based treatment liquid composition. In addition, in this embodiment, the “water-based” composition indicates a composition having a water content of 30.0 percent by mass or more with respect to the total mass thereof.

### 1.5. Cross-Linking Agent

The treatment liquid composition preferably further contains a cross-linking agent.

When the treatment liquid composition contains a cross-linking agent, a cross-linking property can be imparted thereto, and hence, the resin particles, the dye, and the cloth can be bonded to each other. Accordingly, the pre-treatment marks are unlikely to remain, and a printed matter having not only excellent texture characteristics but also a more excellent color development property tends to be obtained. The cross-linking agent may be used alone, or at least two types thereof may be used in combination.

As the cross-linking agent, a known cross-linking agent may be appropriately selected and used, and a cross-linking agent to initiate a cross-linking reaction at an ordinary temperature or a cross-linking agent to initiate a cross-linking reaction by heat may be used. As the cross-linking agent as described above, for example, there may be mentioned a cross-linking agent having a self cross-linking property, a compound having in its molecule, a plurality of functional groups to react with an unsaturated carboxylic acid component, or a metal having at least one polyvalent coordination site.

Since the pre-treatment marks are unlikely to remain, and a printed matter having not only more excellent texture characteristics but also a further excellent color development property tends to be obtained, as the cross-linking agent, at least one selected from the group consisting of an isocyanate group-containing compound and an oxazoline group-containing compound is preferably contained, and an isocyanate group-containing compound is more preferably contained.

As the isocyanate group-containing compound, for example, a water disperse (block) polyisocyanate may be mentioned. The (block) polyisocyanate indicates a polyisocyanate and/or a block polyisocyanate. Those isocyanate group-containing compounds may be used alone, or at least two types thereof may be used in combination.

As the water disperse polyisocyanate, for example, there may be mentioned a polyisocyanate which has a hydrophilic property imparted by a poly(ethylene oxide) chain and which is dispersed in water using an anionic dispersant or a nonionic dispersant.

As the polyisocyanate, for example, there may be mentioned a diisocyanate, such as hexamethylene diisocyanate or isophorone diisocyanate; or a polyisocyanate derivative (modified material), such as a trimethylolpropane adduct, a biuret compound, or an isocyanurate compound of at least one of the diisocyanates mentioned above. In addition, the polyisocyanate may have an isocyanurate skeleton in its structure. Those polyisocyanates may be used alone, or at least two types thereof may be used in combination.

The water disperse block polyisocyanate is a compound in which an isocyanate group of a water disperse polyisocyanate is blocked by a blocking agent. As the blocking agent, for example, there may be mentioned diethyl malonate, ethyl acetoacetate, ε-caprolactam, butanone oxime, cyclohexanone oxime, 1,2,4-triazole, dimethyl-1,2,4-triazole, 3,5-dimethyl pyrazole, or imidazole. Those blocking agents may be used alone, or at least two types thereof may be used in combination.

As the cross-linking agent, an isocyanate group-containing compound having an isocyanurate skeleton in its structure is preferable, and a water disperse poly isocyanate having an isocyanurate skeleton in its structure is more preferable. Since the isocyanate group-containing compound having an isocyanurate skeleton has at least three cross-linking points, adhesion between the resin particles and the cloth tends to be made more preferable. Hence, the pre-treatment marks are unlikely to remain, and a printed matter having not only excellent texture characteristics but also a further excellent color development property tends to be obtained.

As the isocyanate group-containing compound as described above, a commercial product may also be used. As the commercial product, for example, there may be mentioned Fixer #100ECO, #104EA, #220, 70ECO, #70, #410, or #400 (trade name, manufactured by Murayama Chemical Laboratory Co., Ltd.); Elastron (registered trademark) BN-11, BN-27, BN-69, or BN-77 (trade name, manufactured by DKS Co., Ltd.).

As the oxazoline group-containing compound, for example, a compound having at least two oxazoline groups in its molecule may be mentioned. As the oxazoline group-containing compound as described above, for example, there may be mentioned 2,2′-bis(2-oxazoline), 2,2′-methylene-bis(2-oxazoline), 2,2′-ethylene-bis(2-oxazoline), 2,2′-trimethylene-bis(2-oxazoline), 2,2′-tetramethylene-bis(2-oxazoline), 2,2′-hexamethylene-bis(2-oxazoline), 2,2′-octamethylene-bis(2-oxazoline), 2,2′-ethylene-bis(4,4′-dimethyl-2-oxazoline), 2,2′-p-phenylene-bis(2-oxazoline), 2,2′-m-phenylene-bis(2-oxazoline), 2,2′-m-phenylene-bis(4,4′-dimethyl-2-oxazoline), bis(2-oxazolinyl cyclohexane) sulfide, bis(2-oxazolinyl norbornane) sulfide, or an oxazoline ring-containing polymer. The oxazoline group-containing compounds may be used alone, or at least two types thereof may be used in combination.

Since the pre-treatment marks are unlikely to remain, and a printed matter having not only excellent texture characteristics but also a more excellent color development property tends to be obtained, as the oxazoline group-containing compound, a water soluble oxazoline group-containing compound is preferably contained.

As the oxazoline group-containing compound as described above, a commercial product may also be used. As the commercial product, for example, there may be mentioned Epocros (registered trademark) K-2010, K-2020, K-2030, K-2035E, WS-300, WS-500, or WS-700 (trade name, manufactured by Nippon Shokubai Co., Ltd.).

Since the pre-treatment marks are more unlikely to remain, and a printed matter more excellent in color development property and texture characteristics tends to be obtained, a content of the cross-linking agent with respect to the total mass of the treatment liquid composition is preferably 0.5 to 5.0 percent by mass on a solid content basis. Since the pre-treatment marks are more unlikely to remain, and a printed matter having not only more excellent texture characteristics but also a further excellent color development property tends to be obtained, the content of the cross-linking agent with respect to the total mass of the treatment liquid composition is more preferably 1.5 to 4.5 percent by mass on a solid content basis. Since the pre-treatment marks are more unlikely to remain, and a printed matter even more excellent in color development property and texture characteristics tends to be obtained, the content of the cross-linking agent with respect to the total mass of the treatment liquid composition is further preferably 1.5 to 2.5 percent by mass on a solid content basis.

### 1.6. Organic Solvent

The treatment liquid composition preferably further contains an organic solvent.

Since the treatment liquid composition further contains an organic solvent, the pre-treatment marks are unlikely to remain on the dye-printed cloth, and in addition, a printed matter having not only excellent texture characteristics but also a more excellent color development property can be obtained. The organic solvent may be used alone, or at least two types thereof may be used in combination.

As the organic solvent, for example, there may be mentioned glycerin; a glycol, such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, or 1,6-hexanediol; a glycol monoether, such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, or methyl triglycol; a nitrogen-containing solvent, such as 2-pyrrolidone, N-methyl-2-pyrrolidone, or N-ethyl-2-pyrrolidone; or an alcohol, such as methanol, ethanol, n-propyl alcohol, iso-propyl alcohol, n-butanol, 2-butanol, tert-butanol, iso-butanol, n-pentanol, 2-pentanol, 3-pentanol, or tert-pentanol.

Since the pre-treatment marks are further unlikely to remain, and a printed matter further excellent in color development property and texture characteristics can be obtained, as the organic solvent, a glycol is preferably contained, and 1,2-hexanediol is more preferably contained.

A content of the organic solvent with respect to the total mass of the treatment liquid composition is preferably 5.0 percent by mass or more, more preferably 5.0 to 30.0 percent by mass, and further more preferably 10.0 to 20.0 percent by mass. Since the content of the organic solvent is set in the range described above, the pre-treatment marks are further unlikely to remain, and a printed matter further excellent in color development property and texture characteristics tends to be obtained.

### 1.7. Other Components

In the treatment liquid composition, various additives, such as a surfactant, a solubilizing agent, a moisturizer, a pH adjuster, an antioxidant, an antiseptic agent, a fungicide, a corrosion inhibitor, and/or a chelating agent may also be contained.

The additives may be used alone, or at least two types thereof may be used in combination.

A content of each of the additives with respect to the total mass of the treatment liquid composition is, for example, 0.01 to 5.0 percent by mass.

### 1.8. Preparation Method of Treatment Liquid Composition

The treatment liquid composition may be prepared in a manner such that the individual components are mixed together in an arbitrary order, and if needed, impurities, foreign substances, and the like are then removed by filtration or the like. As a mixing method of the individual components, there may be used a method in which the individual components are stirred and mixed together after being sequentially added in a container equipped with a stirring device, such as a mechanical stirrer or a magnetic stirrer. As a filtration method, for example, a centrifugal filtration or a filter filtration may be mentioned.

### 2. Ink Jet Ink Composition

An ink jet ink composition (hereinafter, also referred to as “ink composition” in some cases) is used to manufacture a printed matter by printing a cloth to which the treatment liquid composition of this embodiment is adhered. Next, the ink composition will be described.

The ink composition according to this embodiment contains a disperse dye and water.

### 2.1. Disperse Dye

Since an excellent color development property tends to be imparted to the cloth to which the treatment liquid composition is adhered, the ink composition contains a disperse dye as the dye. The disperse dye is generally in the form of particles and is a colorant to be dispersed in a dispersion medium by a dispersant. In addition, the disperse dye is, in general, a nonionic dye having a hydrophilic group and an appropriate polar group. The disperse dye may be used alone, or at least two types thereof may be used in combination.

As the disperse dye, for example, there may be mentioned C.I. Disperse Yellow, C.I. Disperse Red, C.I. Disperse Blue, C.I. Disperse Orange, C.I. Disperse violet, C.I. Disperse Green, C.I. Disperse Brown, or C.I. Disperse Black.

Among those mentioned above, as the disperse dye, a sublimation dye is preferable. In this specification, the “sublimation dye” indicates a dye having a sublimation property by heating.

As the sublimation dye mentioned above, for example, in particular, there may be mentioned C.I. Disperse Yellow 3, 7, 8, 23, 39, 51, 54, 60, 71, or 86; C.I. Disperse Orange 1, 1:1, 5, 20, 25, 25:1, 33, 56, or 76; C.I. Disperse Brown 2; C.I. Disperse Red 11, 50, 53, 55, 55:1, 59, 60, 65, 70, 75, 93, 146, 158, 190, 190:1, 207, 239, or 240; C.I. Vat Red 41; C.I. Disperse Violet 8, 17, 23, 27, 28, 29, 36, or 57; C.I. Disperse Blue 14, 19, 26, 26:1, 35, 55, 56, 58, 64, 64:1, 72, 72:1, 81, 81:1, 91, 95, 108, 131, 141, 145, or 359; or C.I. Solvent blue 36, 63, 105, or 111.

In this embodiment, since a more preferable dyeing property can be imparted to the cloth to which the treatment liquid composition is adhered, and a printed matter having a sufficient color development property tends to be obtained, a cyan dye, a red dye, and a yellow dye is preferable. Since a further preferable dyeing property can be obtained, and a printed matter having a sufficient color development property tends to be obtained, as the cyan dye, C.I. Disperse Blue 359 is preferable. As the red dye, C.I. Disperse Red 60 is preferable. As the yellow dye, C.I. Disperse Yellow 54 is preferable.

In order to more effectively and reliably obtain the functional effect of this embodiment, a content of the colorant with respect to a total mass of the ink composition is preferably 0.05 to 20.0 percent by mass.

### 2.2. WATER

The ink composition contains water.

As the water, the water described in the above treatment liquid composition including the preferable case thereof may be mentioned as reference.

In order to more effectively and reliably obtain the functional effect of this embodiment, a content of the water with respect to the total mass of the ink composition is preferably 30.0 to 80.0 percent by mass.

### 2.3. Dispersant

The ink composition may also contain a dispersant.

When the ink composition contains a dispersant, a dispersibility of the disperse dye is made excellent, and a clogging recovery property of the ink composition is also made excellent. As the dispersant, for example, a naphthalene sodium sulfonate/formalin condensate or a resin may be mentioned. The naphthalene sodium sulfonate/formalin condensate is a compound obtained by formalin condensation of a sulfonated compound having a naphthalene ring in its molecule or is a salt thereof. The dispersant may be used alone, or at least two types thereof may be used in combination.

Since a more preferable dispersibility can be obtained, as the dispersant, the resin is preferably contained. As the resin, for example, there may be mentioned an urethane-based resin, a styrene-acrylic-based resin, an acrylic-based resin, a fluorene-based resin, a polyolefin-based resin, a rosin modified resin, a terpene-based resin, a polyester-based resin, a polyamide-based resin, an epoxy-based resin, a vinyl chloride-based resin, a vinyl chloride-vinyl acetate copolymer, or an ethylene-vinyl acetate-based resin. Among those mentioned above, since the clogging recovery property is superior, as the resin, an urethane-based resin or a styrene-acrylic-based resin is preferable, and a styrene-acrylic-based resin is more preferable.

As the urethane-based resin, a resin is not particularly limited as long as having an urethane bond in its molecule. As the urethane-based resin, there may be mentioned a polyether type urethane resin having, besides an urethane bond, an ether bond in its main chain, a polyester type urethane resin having, besides an urethane bond, an ester bond in its main chain, or a polycarbonate type urethane resin having, besides an urethane bond, a carbonate bond in its main chain. The urethane-based resin may be used alone, or at least two types thereof may be used in combination.

As the urethane-based resin, a commercial product may also be used. As the commercial product, for example, there may be mentioned Takelac (registered trademark) W6110 (trade name, manufactured by Mitsui Chemicals, Inc.); Acrit (registered trademark) WBR-022U (trade name, manufactured by Taisei Fine Chemical Co., Ltd.); Permarin (registered trademark) UX-368T (trade name), Uprene (registered trademark) UXA-307 (trade name), or Ucoat (registered trademark) UWS-145 (trade name) (each manufactured by Sanyo Chemical Industries, Ltd.); or Solsperse (registered trademark) 47000 (trade name, manufactured by Lubrizol).

As the styrene-acrylic-based resin, for example, there may be mentioned a styrene-acrylic acid copolymer, a styrene-methacrylic acid copolymer, a styrene-methacrylic acid-acrylic acid ester copolymer, a styrene-α-methylstyrene-acrylic acid copolymer, or a styrene-α-methylstyrene-acrylic acid-acrylic acid ester copolymer. Those copolymers each may be one of a random copolymer, a block copolymer, an alternate copolymer, and a graft copolymer.

As the styrene-acrylic-based resin, a commercial product may also be used. As the commercial product, for example, there may be mentioned Joncryl (registered trademark) 67 (trade name, manufactured by BASF Japan Ltd.) or Solsperse (registered trademark) 43000 (trade name, manufactured by Lubrizol).

In order to more effectively and reliably obtain the functional effect of this embodiment, a content of the dispersant with respect to the total mass of the ink composition is preferably 3.0 to 8.0 percent by mass.

### 2.4. Surfactant

The ink composition may also contain a surfactant.

As the surfactant, for example, there may be mentioned an acetylene glycol-based surfactant, a fluorine-based surfactant, or a silicone-based surfactant. The surfactant may be used alone, or at least two types thereof may be used in combination.

As the acetylene glycol-based surfactant, for example, 2,4,7,9-tetramethyl-5-decyne-4,7-diol, an alkylene oxide adduct thereof, 2,4-dimethyl-5-decyne-4-ol, or an alkylene oxide adduct thereof may be mentioned.

As the acetylene glycol-based surfactant, a commercial product may also be used. As the commercial product, for example, there may be mentioned Olfine (registered trademark) 104 series (trade name) or E series (trade name) manufactured by Nissin Chemical Industry Co., Ltd., or Surfynol (registered trademark) series (trade name) manufactured by Air Products & Chemicals Inc.

As the fluorine-based surfactant, for example, there may be mentioned a perfluoroalkyl sulfonate salt, a perfluoroalkyl carboxylate salt, a perfluoroalkyl phosphate ester, a perfluoroalkyl ethylene oxide adduct, a perfluoroalkyl betaine, or a perfluoroalkylamine oxide compound.

As the fluorine-based surfactant, a commercial product may also be used. As the commercial product, for example, there may be mentioned S-144 (trade name) or S-145 (trade name) manufactured by AGC Inc.

As the silicone-based surfactant, a polysiloxane-based compound or a polyether modified organosiloxane may be mentioned.

As the silicone-based surfactant, a commercial product may also be used. As the commercial product, for example, there may be mentioned BYK (registered trademark) series, 306, 307, 333, 341, 345, 346, 347, 348, or 349 (trade name, manufactured by BYK Japan KK).

In order to more effectively and reliably obtain the functional effect of this embodiment, a content of the surfactant with respect to the total mass of the ink composition is preferably 0.5 to 5.0 percent by mass.

### 2.5. Water-Soluble Organic Solvent

The ink composition may also contain a water-soluble organic solvent.

As the water-soluble organic solvent, for example, there may be mentioned glycerin; a glycol, such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, or 1,6-hexanediol; a glycol monoether, such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, or methyl triglycol; a nitrogen-containing solvent, such as 2-pyrrolidone, N-methyl-2-pyrrolidone, or N-ethyl-2-pyrrolidone; or an alcohol, such as methanol, ethanol, n-propyl alcohol, iso-propyl alcohol, n-butanol, 2-butanol, tert-butanol, iso-butanol, n-pentanol, 2-pentanol, 3-pentanol, or tert-pentanol.

The water-soluble organic solvent may be used alone, or at least two types thereof may be used in combination.

Glycerin, a glycol, or a glycol monoether is able to function primarily as a permeation solvent and/or a moisturizer. A glycol monoether tends to have a strong property as the permeation solvent, and glycerin and a glycol tend to have a strong property as the moisturizer.

In order to more effectively and reliably obtain the functional effect of this embodiment, a content of the water-soluble organic solvent with respect to the total mass of the ink composition is preferably 5.0 to 30.0 percent by mass.

### 2.6. Other Components

The ink composition may contain various additives, such as a solubilizing agent, a viscosity adjuster, a pH adjuster, an antioxidant, an antiseptic agent, a fungicide, a corrosion inhibitor, and/or a chelating agent to trap metal ions influencing the dispersion may also be contained.

The additives may be used alone, or at least two types thereof may be used in combination.

As the antiseptic agent, there may be mentioned sodium pentachlorophenol, sodium 2-pyridinethiol-1-oxide, or 1,2-dibenzinethiazoline-3-one.

As the antiseptic agent, a commercial product may also be used. As the commercial product, for example, Proxel (registered trademark) CRL, BND, GXL, XL-2, or TN (trade name, manufactured by Lonza K.K.) may be mentioned. The antiseptic agent may be used alone, or at least two types thereof may be used in combination.

A content of each of the additives with respect to the total mass of the ink composition is 0.01 to 5.0 percent by mass.

### 2.7. Method for Manufacturing Ink Composition

The ink composition may be prepared in a manner such that after the disperse dye, the water, and if needed, the other components are mixed together in an arbitrary order, impurities, foreign substances, and the like are removed, if needed, by filtration or the like. As a mixing method of the individual components, there may be used a method in which the individual components are stirred and mixed together after being sequentially added in a container equipped with a stirring device, such as a mechanical stirrer or a magnetic stirrer. As a filtration method, for example, a centrifugal filtration or a filter filtration may be mentioned.

In addition, in order to more preferably disperse the disperse dye in the ink composition, a dye dispersant is prepared in advance, and the ink composition may be prepared using the dye dispersant instead of using the disperse dye. The dye dispersant may be obtained in a manner such that for example, the disperse dye, the water, and the dispersant are mixed together in an arbitrary order and then dispersed using a paint shaker or the like.

### 3. Composition Set

A composition set includes the above treatment liquid composition and the above ink composition.

In this embodiment, the treatment liquid composition is adhered to a cloth in advance, so that the cloth to which the treatment liquid composition is adhered is obtained. In addition, printing is performed on the cloth to which the treatment liquid composition is adhered using the ink composition. Since the treatment liquid composition is used, on the dye-printed cloth, the pre-treatment marks are unlikely to remain, and in addition, a printed matter excellent in color development property and texture characteristics can be obtained.

### 4. Cloth

As the cloth according to this embodiment, for example, there may be mentioned natural fibers of cotton, hemp, wool (sheep wool), leather, silk, or the like; synthetic fibers of a nylon, a polypropylene, a polyester, an acetate, a triacetate, a polyamide, an acrylic resin, a polyurethane, or the like; biodegradable fibers of a poly(lactic acid) or the like; a metal, such as iron, zinc, stainless steel, aluminum, gold, silver, copper, or the like; a plastic, such as a polyethylene, a polypropylene, a poly(ethylene terephthalate), or the like; or paper. In addition, as the cloth, blended fibers using at least one type of those mentioned above may also be used.

Since the pre-treatment marks are more unlikely to remain on the dye-printed cloth, and a printed matter more excellent in color development property and texture characteristics tends to be obtained, as the cloth, cotton, hemp, nylon, wool, acrylic resin, silk, leather, polyester, metal, plastic, or paper is preferable, fibers having hydroxy groups are more preferably contained, and cotton is further preferable. As the fibers having hydroxy groups, blended fibers of those mentioned above may also be used.

As the form of the cloth, for example, there may be mentioned a woven fabric, a knitted fabric, a non-woven cloth, and a cloth, and clothes and other accessories. In the clothes and other accessories, sewn products, such as a T shirt, a handkerchief, a scarf, a towel, a handbag, and a fabric-made bag; furniture, such as a curtain, a sheet, a bed cover, and wallpaper; and fabrics before and after cutting to be used as materials to be sewn. As the forms of those fabrics, for example, there may be mentioned a fabric having a long length in a roll shape, a fabric cut to have a predetermined size, and a fabric having a product shape. In addition, the cloth may be used as long as the treatment liquid composition is adhered thereto, and a cloth to which the treatment liquid composition is adhered in advance may also be used.

The basis weight of the cloth is, for example, 1.0 to 10.0 Oz. When the basis weight is in the range described above, a preferable recording can be performed.

As the cloth, a white cloth is preferable. Although a white cloth is used, since the treatment liquid composition is used, the pre-treatment marks are unlikely to remain on the dye-printed cloth, and in addition, a printed matter excellent in color development property and texture characteristics can be obtained.

In addition, as the cloth, white cotton-made furniture, such as a white cotton T shirt, is more preferable. In the white cotton-made furniture, in general, although a component to maintain and improve the degree of whiteness is allowed to remain, by the use of the treatment liquid composition, even if the component as described above remains, the pre-treatment marks are unlikely to remain on the dye-printed cloth, and in addition, a printed matter excellent in color development property and texture characteristics can be obtained.

As the cloth, a cloth colored in advance by the dye may also be used. Since the treatment liquid composition is unlikely to generate the pre-treatment marks, even the cloth colored in advance can also be used. That is, even when a fabric is colored, printing to suppress the generation of the pre-treatment marks can be performed, and hence, the quality and the commercial value of the printed matter as the product can be enhanced compared to those in the past.

As the dye to color the cloth in advance, for example, a water soluble dye, such as an acidic dye or a basic dye; a disperse dye to be used together with a dispersant; a reactive dye, or a solvent dye may be mentioned. As the cloth, when a cotton cloth is used, a disperse dye or a reactive dye suitable for cotton dyeing is preferable, and a disperse dye is more preferable.

### 5. Printing Method 5.1. TREATMENT LIQUID COMPOSITION ADHESION STEP

A printing method of this embodiment includes a treatment liquid composition adhesion step of adhering the treatment liquid composition to the cloth.

Through the step described above, the cloth to which the treatment liquid composition is adhered is obtained. In addition, although the ink composition is adhered to the cloth described above, since the treatment liquid composition is used, the pre-treatment marks are unlikely to remain on the dye-printed cloth, and in addition, a printed matter excellent in color development property and texture characteristics can be obtained.

The printing method can be applied to various types of cloths, and a preferable printing can be performed.

The printing method preferably includes, after the treatment liquid composition adhesion step described above, an ink composition adhesion step of adhering an ink composition to the cloth to which the treatment liquid composition is adhered. In addition, the ink composition to be adhered to the cloth is not particularly limited as long as containing a disperse dye, and for example, the ink jet ink composition according to this embodiment may be used. In addition, the ink composition adhesion step may be performed with reference to a printing method using an ink jet method which will be described later.

The treatment liquid composition is adhered to the cloth, for example, so as to have an adhesion amount of 0.02 to 0.5 g/cm2 and is preferably adhered thereto to have an adhesion amount of 0.02 to 0.3 g/cm². Since the adhesion amount of the treatment liquid composition is set in the range described above, the treatment liquid composition can be more uniformly adhered to the cloth, aggregation irregularity of an image of the printed matter can be further suppressed, and the color development property thereof can be enhanced.

As a method to adhere the treatment liquid composition to the cloth, for example, there may be mentioned a dip coating method to dip the cloth in the treatment liquid composition, a roller coating method to apply the treatment liquid composition using a mangle roller, a roller coater, or the like, a spray coating method to spray the treatment liquid composition by a sprayer or the like, or an ink jet coating method to eject the treatment liquid composition by an ink jet method. By using one of the coating methods described above or at least two thereof in combination, the treatment liquid composition may be adhered to the cloth.

In this embodiment, since the degree of design freedom of the adhesion amount of the treatment liquid composition is increased, defects caused by the adhesion thereof are unlikely to occur, and the treatment liquid composition can be uniformly adhered to the cloth, the treatment liquid composition is preferably adhered to the cloth using a roller, such as a mangle roller or a roller coater.

### 5.2. Drying Step

The printing method preferably includes, after the treatment liquid composition adhesion step of adhering the treatment liquid composition to the cloth, a drying step of drying the treatment liquid composition adhered to the cloth. Although the drying of the treatment liquid composition may be performed by spontaneous drying, since the adhesion amount of the treatment liquid composition to the cloth is increased, and in addition, a drying rate is also improved, the drying is preferably performed with heating.

Since the pre-treatment marks are more unlikely to remain on the dye-printed cloth, and a printed matter more excellent in color development property and texture characteristics tends to be obtained, a drying temperature is preferably 300° C. or less and more preferably 200° C. or less. In addition, since an upper limit of the drying temperature is set in the range described above, even when the cloth is colored in advance with the dye, sublimation of the dye by heat drying is suppressed, and the original color of the cloth tends to be suppressed from being discolored. A lower limit of the drying temperature may be set so that a medium, such as water, contained in the treatment liquid composition is evaporated and is preferably 50° C. or more, more preferably 100° C. or more, and further preferably 110° C. or more.

As a heating method, for example, there may be mentioned a heat press method, a normal pressure steaming method, a high pressure steaming method, or a thermo fix method. In addition, as a heat source of the heating, for example, a hot wind, an infrared (lamp), or a microwave may be mentioned.

A heating temperature is preferably set to 1 second to 5 minutes. Since the heating time is in the range described above, volatile components, such as an organic solvent and water, can be preferably evaporated from the cloth, and damage on the cloth tends to be reduced.

In the printing method, after the treatment liquid composition is adhered to the cloth, if needed, a washing step may also be included. Since the printing method includes this step, components which are contained in the treatment liquid composition and which are not adhered to the cloth can be removed.

### 6. Ink Jet Printing Method

An ink jet printing method is a method for adhering the ink jet composition to the cloth to which the treatment liquid composition is adhered using an ink jet method. Since the ink jet method is used, a dyeing portion having a fine pattern can be easily and reliably formed. In addition, the method described above can be applied to various types of cloths, and a preferable printing can be performed thereon. By the ink jet printing method, even on a thick fabric, a preferable printing having a less difference in color density between front and rear surfaces can be performed. As the ink jet printing method, for example, an indirect ink jet recording method and a direct ink jet recording method may be mentioned.

### 6.1. Ink Jet Recording Apparatus

An ink jet recording apparatus used for the printing method is not particularly limited when the apparatus includes at least an ink receiver to receive the ink composition and a recording head connected thereto and is able to form an image on the cloth to which the treatment liquid composition is adhered or on transfer paper functioning as an intermediate transfer medium by ejecting the ink composition from the recording head. In addition, as the ink jet recording apparatus, either a serial type or a line type apparatus can be used. In the ink jet recording apparatus of each type, the recording head is mounted, and while a relative positional relationship between the recording head and the cloth or the transfer paper is changed, liquid droplets of the ink composition each having a predetermined volume are intermittently ejected from nozzle holes of the recording head at a predetermined timing. Accordingly, the ink composition is adhered to the cloth or the transfer paper, so that a predetermined image or a predetermined transfer image can be formed.

In general, in the serial type ink jet recording apparatus, a transport direction of the recording medium and a reciprocal operation direction of the recording head are intersected, and by the combination between the reciprocal operation of the recording head and the transport operation of the recording medium, the relative positional relationship between the recording medium and the recording head is changed. In addition, in the case described above, in general, a plurality of nozzle holes is provided in the recording head, and along the transport direction of the recording medium, a line of nozzle holes, that is, a nozzle line, is formed. In addition, in the recording head, in accordance with the types and the number of ink compositions, a plurality of nozzle lines may be formed in some cases.

In addition, in general, in the line type ink jet recording apparatus, the reciprocal operation of the recording head is not performed, and the relative positional relationship between the recording medium and the recording head is changed by the transport of the recording medium. In the case described above, in general, the nozzle holes are also disposed in the recording head, and along the direction intersecting the transport direction of the recording medium, the nozzle line is formed.

### 6.2. Indirect Printing Recording Method

An ink jet printing method of this embodiment includes a treatment liquid composition adhesion step of adhering the treatment liquid composition to the cloth, an ejection step of ejecting the ink composition from the recording head so as to be adhered to the intermediate transfer medium, and a transfer step of transferring the ink composition adhered to the intermediate transfer medium to the cloth to which the treatment liquid composition is adhered by the treatment liquid composition adhesion step. In particular, in this printing method, an ink composition containing a disperse dye, such as a sublimation dye, is ejected by a liquid ejection head which is the recording head so as to be adhered to the intermediate transfer medium, and a surface of the intermediate transfer medium to which the ink composition is adhered and a cloth surface to which the treatment liquid composition is adhered are place to face each other and are then heated, so that the disperse dye contained in the ink composition is transferred to the cloth to which the treatment liquid composition is adhered. In this embodiment, the printing method as described above is also called an indirect printing recording method. By this printing method, the form of the cloth is not particularly limited, and a preferable printing can be performed.

### 6.2.1. Treatment Liquid Composition Adhesion Step

The treatment liquid composition adhesion step may be performed with reference to the printing method described above.

### 6.2.2. Ejection Step

In the ejection step, a heated ink composition is ejected from the liquid ejection head and is adhered to the intermediate transfer medium. In particular, a pressure generating device is driven, and the ink composition filled in a pressure generating chamber of the liquid ejection head is ejected from the nozzle.

As the intermediate transfer medium, for example, paper, such as regular paper, or a recording medium including an ink receiving layer may be used. The recording medium including an ink receiving layer is also called, for example, ink jet exclusive paper or coated paper. Among the recording media described above, paper including an ink receiving layer containing inorganic particles, such as silica, is more preferable. Accordingly, by a process to dry the ink composition applied to the intermediate transfer medium, an intermediate recorded matter in which, for example, bleeding on a recording surface is suppressed can be obtained. In addition, by the medium as described above, the disperse dye can be more easily allowed to stay on the recording surface, and in the following transfer step, the sublimation of the disperse dye can be more efficiently performed.

In this step, a plurality of ink compositions may also be used. Accordingly, for example, a color gamut to be displayed can be made wider. One of the plurality of ink compositions described above may be the ink composition of this embodiment, and at least two thereof each may also be the ink composition of this embodiment.

### 6.2.3. Transfer Step

The transfer step is a step in which the surface of the intermediate transfer medium to which the ink composition is adhered and the cloth surface to which the treatment liquid composition is adhered are placed to face each and are then heated, so that the disperse dye contained in the ink composition is transferred to the cloth to which the treatment liquid composition is adhered. Accordingly, the disperse dye is transferred, and hence, a printed matter which is the cloth to which the ink composition is adhered is obtained.

In this step, while the intermediate transfer medium to which the ink composition is applied is placed to face the cloth to which the treatment liquid composition is adhered, heating may be performed. In this step, while the intermediate transfer medium to which the ink composition is applied and the cloth to which the treatment liquid composition is adhered are placed in a close contact state, the heating is more preferably performed. Accordingly, for example, a clearer image can be recorded on the cloth to which the treatment liquid composition is adhered, that is, a dye printing can be performed.

As a heating method, for example, steaming with vapor, a heat press with dry heat, a thermosol, a HT steamer with superheated vapor, or a HP steamer with pressurized vapor may be mentioned. To the cloth to which the ink composition is applied, a heating treatment may be performed immediately or after a predetermined time passes.

Since the pre-treatment marks are more unlikely to remain on the dye-printed cloth, and a printed matter more excellent in color development property and texture characteristics tends to be obtained, as the heating method, a heat press with dry heat is preferable. By the heat press with dry heat, in general, during the heating, moisture contained in the cloth is generated in the form of vapor from a non-pressurized portion. In the case described above, carbonate salts, such as potassium carbonate and sodium carbonate, generated in the cloth are localized in the non-pressurized portion, and the pre-treatment marks may be liable to be generated on the cloth surface in some cases. However, since the total concentration of potassium ions and sodium ions in the treatment liquid composition of this embodiment is 100.0 ppm or less, the carbonate salts are unlikely to be generated in the cloth, and hence, even if the heat press with dry heat is used, the pre-treatment marks derived from the carbonate salts are unlikely to be generated.

A heating temperature is preferably 160° C. to 220° C. and more preferably 190° C. to 210° C. Since the heating temperature is in the range described above, energy required for the transfer can be further decreased, and productivity of the printed matter tends to be made more excellent. In addition, the color development property of the printed matter tends to be made more excellent.

Although depending on the heating temperature, a heating time is preferably 30 to 120 seconds and more preferably 40 to 90 seconds. Since the heating time is in the range described above, the energy required for the transfer can be further decreased, and the productivity of the printed matter tends to be made more excellent. In addition, the color development property of the printed matter tends to be made more excellent.

By the transfer, the adhesion amount of the ink composition adhered to the cloth is, for example, 1.5 to 6.0 mg/cm² per unit area of the cloth. Since the adhesion amount of the ink composition is in the range described above, the color development property of an image or the like formed by the printing is improved, and in addition, since the drying property of the ink adhered to the cloth is secured, the generation of bleeding of an image or the like can be reduced.

### 6.2.4. Other Steps

In this method, if needed, an intermediate treatment step and a post treatment step may also be included.

As the intermediate treatment step, for example, a step of pre-heating the cloth to which the treatment liquid composition is adhered may be mentioned.

As the post treatment step, for example, a step of washing the printed matter may be mentioned.

### 6.3. Direct Printing Recording Method

An ink jet printing method of this embodiment may include a treatment liquid composition adhesion step of adhering the treatment liquid composition to the cloth and an ink composition adhesion step of ejecting the ink composition from the recording head so as to be adhered to the cloth to which the treatment liquid composition is adhered by the treatment liquid composition adhesion step. In this embodiment, the printing method as described above is also called a direct printing recording method. By this printing method, a dyeing portion having a fine pattern can be easily and reliably formed. In addition, since a plate, such as the intermediate transfer medium, is not required, the direct printing recording method is excellent in terms of on-demand characteristics and can be preferably applied to a small-quantity production and/or a multi-item production.

### 6.3.1. Treatment Liquid Composition Adhesion Step

The treatment liquid composition adhesion step may be performed with reference to the printing method described above.

### 6.3.2. Ink Composition Adhesion Step

In the ink composition adhesion step, the ink composition is adhered to the cloth to which the treatment liquid composition is adhered. In addition, in the ink composition adhesion step, on a region to which the ink composition is adhered, a step of further adhering the ink composition may also be included.

In the ink composition adhesion step, the maximum adhesion amount to the cloth is preferably 50 to 200 mg/cm² and more preferably 80 to 150 mg/cm². When the maximum adhesion amount is in the range described above, the color development property is made more preferable. In addition, an abrasion fastness of an image is also made excellent, and the aggregation irregularity tends to be made inconspicuous.

In this step, when the ink composition is adhered to the cloth to which the treatment liquid composition is adhered, heating is preferably performed. Accordingly, for example, a clearer image is recorded on the cloth to which the treatment liquid composition is adhered, that is, a dye printing can be performed.

As a heating method, the method described in the drying step of the above printing method may be mentioned as reference.

In the heating, a surface temperature of the heated cloth is preferably 60° C. to 180° C. Since the surface temperature is in the range described above, damage on the ink jet head and the cloth can be reduced, and in addition, the ink is likely to uniformly wet-spread on the cloth and is also likely to permeate therein. In addition, the surface temperature can be measured using a contactless thermometer (trade name, “IT2-80”, manufactured by Keyence Corporation) or the like.

A heating time is preferably 5 seconds to 5 minutes. Since the heating time is in the range described above, while the damage on the ink jet head and the cloth is reduced, the cloth can be sufficiently heated.

### 6.3.3. Other Steps

In this method, if needed, an intermediate treatment step and a post treatment step may also be included. Those steps may be performed with reference to the other steps of the indirect printing recording method described above.

### EXAMPLES

Hereinafter, the present disclosure will be described in more detail with reference to Examples (each abbreviated as “Ex.” in tables) and Comparative Examples (each abbreviated as “Com.ex.” in tables). The present disclosure is not at all limited to the following Examples.

### 1. DYE PRINTING TREATMENT LIQUID COMPOSITION

### 1.1. Preparation of Dye Printing Treatment Liquid Composition

### [Examples 1 to 18 and Comparative Examples 1 to 3] (Treatment Liquids 1 to 21)

In order to obtain the compositions shown in Tables 1 and 2, after individual components were charged in a mixing tank and then mixed and stirred, filtration was performed using a 5-μm membrane filter, so that as the treatment liquid compositions, treatment liquids 1 to 21 were obtained.

In addition, the numerical values of the amounts of the individual components in Tables 1 and 2 are each shown on a mass percent basis. The amounts of the resin particles and the cross-linking agent each indicate the amount on a solid content basis (percent by mass). “Tg” of the resin particles indicates the glass transition temperature (° C.). As the pure water, ion exchange water was used and was added so that the mass of each treatment liquid composition was 100 percent by mass.

In addition, the individual components shown in Tables 1 and 2 are as described below.

### (Resin Particles)·

KT-0507 Elitel (registered trademark) KT-0507 (trade name, manufactured by Unitika Ltd., solid content: 25 percent by mass, glass transition temperature Tg: −25° C.)
KT-8701 Elitel (registered trademark) KT-8701 (trade name, manufactured by Unitika Ltd., solid content: 30 percent by mass, glass transition temperature Tg: 15° C.)
KT-8803 Elitel (registered trademark) KT-8803 (trade name, manufactured by Unitika Ltd., solid content: 30 percent by mass, glass transition temperature Tg: 65° C.) (CROSS-LINKING AGENT)
#220 Fixer #220 (trade name, manufactured by Murayama Chemical Laboratory Co. Ltd., isocyanate group-containing compound having an isocyanurate skeleton in its structure, solid content: 40 percent by mass)
WS-500 Epocros (registered trademark) WS-500 (trade name, manufactured by Nippon Shokubai Co., Ltd., oxazoline group-containing compound, solid content: 39 percent by mass) (THICKENER)
K-17P SOKALAN (registered trademark) K-17P (trade name, manufactured by BASF SE, poly(vinyl pyrrolidone)).
K30 PITZCOL (registered trademark) K-30 (trade name, manufactured by DKS Co., Ltd., poly(vinyl pyrrolidone))
621TF SN Thickener 621TF (trade name, manufactured by San Nopco Ltd., urethane-modified polyether)
KELZAN T KELZAN (registered trademark) T (trade name, manufactured by Sansho Co., Ltd., xanthan gum)
CEKOL CEKOL (registered trademark) 30000 (trade name, manufactured by Sansho Co., Ltd., carboxy methyl cellulose)
sodium alginate

### (Organic Solvent)

1,2-hexanediol

### 1.2. Physical Properties of Dye Printing Treatment Liquid Composition

### 1.2.1. Viscosity

The viscosity (mPa·s) of the dye printing treatment liquid composition of each of Examples 1 to 18 and Comparative Examples 1 to 3 was measured. In particular, by using a viscoelastic measurement apparatus (Modular compact rheometer MCR302e (trade name, manufactured by Anton Paar Ltd.), under conditions at a temperature of 20° C. and a shear rate of 200 sec-1, the viscosity of the dye printing treatment liquid composition was measured. The results are shown in Tables 1 and 2.

### 1.2.2. Total Concentration

The total concentration (ppm) of potassium ions and sodium ions detected from the dye printing treatment liquid composition of each of Examples 1 to 18 and Comparative Examples 1 to 3 was measured. In particular, a centrifugal filtration was performed on 20 g of the dye printing treatment liquid composition at a revolution rate of 8,000 rpm for 5 minutes, and a solid liquid separation was then performed using a 0.2-μm size syringe filter, so that a supernatant solution was recovered. Subsequently, the supernatant solution was diluted with pure water, so that a 100-times diluted solution was prepared. This solution was measured using an ion chromatographic apparatus (940 professional IC Vario (trade name), manufactured by Metrohm), and by the use of a calibration curve prepared in advance, the total concentration (ppm) of potassium ions and sodium ions detected from the dye printing treatment liquid composition was calculated. The results thereof are shown in Tables 1 and 2.

### 2. Preparation of Ink Jet Ink Composition

### [C Ink]

In order to obtain the composition shown in Table 3, individual components were charged in a mixing tank and then mixed and stirred for 2 hours by a stirrer. Subsequently, by filtration using a membrane filter having a pore diameter of 1 μm, as the ink composition, a C ink was obtained. In addition, the numerical values of the individual components in Table 3 are each shown by percent by mass.

In addition, the individual components shown in Table 3 are as described below.

### (Disperse Dye)·

Disperse Blue 359: C.I. Disperse Blue 359 (commercial product)

### (Water-Soluble Organic Solvent)

propylene glycol
glycerin
methyl triglycol

### (Surfactant)

BYK (R)-348: BYK (registered trademark)-348 (trade name, silicone-based surfactant, manufactured by BYK Japan KK)

### 3. Formation of Printed Matter

### 3.1. Formation of Cloth to which Treatment Liquid Composition is Adhered

### Examples 1 to 18 and Comparative Examples 1 to 3

By the use of each of the treatment liquids 1 to 21 as the treatment liquid composition, the treatment liquid composition was adhered to a cloth. In particular, as described below, the cloth to which the treatment liquid composition was adhered was obtained.

As the cloth, a white cotton braid #4000 (trade name, manufactured by Toyobo Co., Ltd.) was immersed in the treatment liquid composition, so that the treatment liquid composition was applied to the cloth by a mangle roller to have a squeezing rate of 80%. Subsequently, after being dried at 140° C. for 2 minutes, the cloth was further dried at 170° C. for one minute, so that each cloth to which the treatment liquid composition was adhered was obtained.

In addition, the squeezing rate(S) was calculated by the following equation (1).

S (%)=[(A−B)/B]×100 (1)

In addition, in the equation (1), S represents the squeezing rate (%), A represents the mass (g) of the cloth to which the treatment liquid composition is adhered, and B represents the mass (g) of the cloth before the treatment liquid composition is adhered.

### 3.2. Formation of Intermediate Recording Medium to which Ink Composition is Adhered

### Examples 1 to 18 and Comparative Examples 1 to 3

The C ink was filled in a cartridge of an ink jet printer PX-G930 (trade name, manufactured by Seiko Epson Corporation). Subsequently, on a surface of a coating layer of coated paper (TRANSJET Sportline 1254 (trade name), manufactured by Chem Paper) used as an intermediate transfer medium, the C ink was adhered under conditions in which the resolution was 720 dpi×720 dpi, and an ink ejection amount corresponding to an ink discharge amount at a duty of 100% was 12 mg/inch², so that an image having a solid pattern was formed. Accordingly, an intermediate recording medium to which the ink composition was adhered was obtained.

### 3.3. Printing

### Examples 1 to 18 and Comparative Examples 1 to 3

The image formed on the surface of the intermediate recording medium to which the ink composition obtained as described above was adhered was thermal transferred to the cloth (cotton braid) to which the treatment liquid composition obtained as described above was adhered using a heat press machine TP-608M (trade name, manufactured by Taiyo Seiki Co., Ltd.) under conditions at a temperature of 200° C. and a pressure of 4.2 N/cm³ for 60 seconds, so that a printed matter which was the cloth to which the C ink was adhered was obtained.

### 4. Evaluation of Printed Matter

### 4.1. Color Development Property

The printed matter of each of Examples 1 to 18 and Comparative Examples 1 to 3 obtained by the above printing was left for 3 days at a room temperature of 25° C. Subsequently, by using a fluorescent spectrodensitometer FD-7 (trade name, manufactured by Konica Minolta, Inc.), under the following conditions at a room temperature of 25° C., the optical density (OD value) of the C ink of each printed matter thus left was measured.

### (Measurement Conditions)

observation light source: D65
observation field of view: 2°
Status: T
polarizing filter: not installed

Next, by using the OD value thus obtained, the color development property of the C ink was evaluated in accordance with the following evaluation criteria. The results are shown in Tables 4 and 5.

### Evaluation Criteria

A: OD value is 1.3 or more.
B: OD value is 1.2 to less than 1.3.
C: OD value is 1.1 to less than 1.2.
D: OD value is less than 1.1.

### 4.2. Texture Characteristics

The texture characteristics of the printed matter of each of Examples 1 to 18 and Comparative Examples 1 to 3 obtained by the printing described above were evaluated by a sensory test. In particular, five judges performed a sensory evaluation on the printed matter thus obtained to evaluate whether “the printed matter is not inferior to the original cloth in hand touch feeling” or “the printed matter is stiff and inferior to the original cloth in hand touch feeling”, and based on this evaluation result, the texture characteristics were evaluated in accordance with the following criteria. In addition, when being evaluated as B or higher, the printed matter was regarded as excellent in texture characteristics. The results are shown in Tables 4 and 5.

### Evaluation Criteria

A: Five judges evaluate “printed matter is not inferior to original cloth in hand tough feeling”.
B: Four judges evaluate “printed matter is not inferior to original cloth in hand tough feeling”.
C: Three judges evaluate “printed matter is not inferior to original cloth in hand tough feeling”.
D: One or two judges evaluate “printed matter is not inferior to original cloth in hand tough feeling”.
E: No judges evaluate “printed matter is not inferior to original cloth in hand tough feeling”.

### 4.3. Pre-Treatment Marks

As the treatment liquid composition, the treatment liquids 1 to 21 were each used, and the treatment liquid composition was adhered to the cloth. In particular, a white T shirt (00085-CVT (trade name), manufactured by TOMS Co., Ltd.) was immersed in the treatment liquid composition as the cloth, so that the treatment liquid composition was applied thereto by a mangle roller to have a squeezing rate of 80%. Subsequently, after being dried at 140° C. for 2 minutes, the cloth was further dried at 170° C. for one minute, so that each cloth B to which the treatment liquid composition was adhered was obtained. In addition, the squeezing rate was as described above.

Next, the image formed on the surface of the intermediate recording medium to which the ink composition was adhered, which was obtained in the above 3.2, was thermal transferred to each cloth (T shirt) to which the treatment liquid composition obtained as described above was adhered at a temperature of 200° C. and a pressure of 4.2 N/cm³ for 60 seconds using a heat press machine TP-608M (trade name, manufactured by Taiyo Seiki Co., Ltd.), so that a printed matter which was the cloth to which the C ink was adhered was obtained.

The pre-treatment marks were evaluated using the printed matter of each of Examples 1 to 18 and Comparative Examples 1 to 3. In particular, by using a fluorescent spectrodensitometer FD-7 (trade name, manufactured by Konica Minolta, Inc.), L values, a* values, and b* values of a pre-treated portion and an untreated portion of the printed matter in the T shirt were measured under the following conditions at a room temperature of 25° C. By the use of the obtained L values, a* values, and b* values, a color change ΔE was calculated, and in accordance with the following evaluation criteria, the pre-treatment marks were evaluated. The results are shown in Tables 4 and 5.
A: ΔE is 0.0 to less than 1.0.
B: ΔE is 1.0 to less than 2.0.
C: ΔE is 2.0 to less than 3.0.
D: ΔE is 3.0 to less than 4.0.
E: ΔE is 4.0 or more.

As shown in Tables 4 and 5, it is found that even when the treatment liquid composition of this embodiment is adhered to the cloth, and the dye printing is performed on the cloth to which the treatment liquid composition is adhered, the pre-treatment marks are unlikely to remain on the dye-printed cloth, and in addition, a printed matter excellent in color development property and texture characteristics can be obtained.

It is also found that when the content of the resin particles with respect to the total mass of the treatment liquid composition is 1.0 to 25.0 percent by mass on a solid content basis, the pre-treatment marks are unlikely to remain, and a printed matter excellent in color development property and texture characteristics tends to be obtained. In addition, from the comparison between Examples 1 to 3, 14, and 15, it is also found that when the content of the resin particles with respect to the total mass of the treatment liquid composition is 4.0 to 25.0 percent by mass on a solid content basis, the pre-treatment marks are unlikely to remain, and a printed matter having not only excellent texture characteristics but also a more excellent color development property tends to be obtained. It is also found that when the content of the resin particles with respect to the total mass of the treatment liquid composition is 3.0 to 15.0 percent by mass on a solid content basis, the pre-treatment marks are unlikely to remain, and a printed matter more excellent in color development property and texture characteristics tends to be obtained.

It is found that when the content of the cross-linking agent with respect to the total mass of the treatment liquid composition is 0.5 to 5.0 percent by mass on a solid content basis, the pre-treatment marks are unlikely to remain, and a printed matter excellent in color development property and texture characteristics tends to be obtained. In addition, from the comparison between Examples 1 to 3, 16, and 17, it is also found that when the content of the cross-linking agent with respect to the total mass of the treatment liquid composition is 1.5 to 4.5 percent by mass on a solid content basis, the pre-treatment marks are unlikely to remain, and a printed matter having not only excellent texture characteristics but also a more excellent color development property tends to be obtained. It is also found that when the content of the cross-linking agent with respect to the total mass of the treatment liquid composition is 1.5 to 2.5 percent by mass on a solid content basis, the pre-treatment marks are unlikely to remain, and a printed matter having not only a more excellent color development property but also more excellent texture characteristics tends to be obtained.

From the comparison between Examples 2 and 18, it is found that since the isocyanate group-containing compound is used as the cross-linking agent, the pre-treatment marks are unlikely to remain, and a printed matter having not only excellent texture characteristics but also a more excellent color development property tends to be obtained.

From the comparison between Examples 2 and 11, it is found that when the organic solvent is contained in the treatment liquid composition, the pre-treatment marks are unlikely to remain, and a printed matter having not only excellent texture characteristics but also a more excellent color development property tends to be obtained.

From the comparison between Examples 2 and 11, it is found that when the content of the organic solvent is 5.0 percent by mass or more with respect to the total mass of the treatment liquid composition, the pre-treatment marks are unlikely to remain, and a printed matter having not only excellent texture characteristics but also a more excellent color development property tends to be obtained.

What is claimed is:

1. A dye printing treatment liquid composition which is used to be adhered to a cloth, the treatment liquid composition comprising:
resin particles;
a thickener; and
water,
wherein the treatment liquid composition has a viscosity of 3.0 mPa·s or more at 20° C., and
a total concentration of potassium ions and sodium ions detected from the treatment liquid composition by an ion chromatographic method is 100.0 ppm or less.

2. The dye printing treatment liquid composition according to claim 1,
wherein the resin particles has a glass transition temperature of 25° C. or more.

3. The dye printing treatment liquid composition according to claim 1, further comprising a cross-linking agent,
wherein the cross-linking agent includes an isocyanate group-containing compound.

4. The dye printing treatment liquid composition according to claim 3,
wherein the isocyanate group-containing compound has an isocyanurate skeleton in its structure.

5. The dye printing treatment liquid composition according to claim 1, further comprising an organic solvent.

6. The dye printing treatment liquid composition according to claim 1,
wherein a content of the resin particles with respect to a total mass of the treatment liquid composition is 1.0 to 25.0 percent by mass on a solid content basis.

7. The dye printing treatment liquid composition according to claim 3,
wherein a content of the cross-linking agent with respect to a total mass of the treatment liquid composition is 0.5 to 5.0 percent by mass on a solid content basis.

8. The dye printing treatment liquid composition according to claim 5,
wherein a content of the organic solvent with respect to a total mass of the treatment liquid composition is 5.0 percent by mass or more.

9. The dye printing treatment liquid composition according to claim 1,
wherein the cloth includes cotton, hemp, nylon, wool, acrylic resin, silk, leather, polyester, metal, plastic, or paper.

10. The dye printing treatment liquid composition according to claim 1,
wherein before the cloth is dye-printed, the treatment liquid composition is used to be adhered to the cloth.

11. A composition set comprising:
the dye printing treatment liquid composition according to claim 1, and
an ink jet ink composition,
wherein the ink jet ink composition includes a disperse dye and water.

12. A printing method comprising:
a treatment liquid composition adhesion step of adhering the dye printing treatment liquid composition according to claim 1 to a cloth.

13. The printing method according to claim 12, further comprising, after the treatment liquid composition adhesion step:
a drying step of drying the treatment liquid composition adhered to the cloth.

14. An ink jet printing method comprising:
a treatment liquid composition adhesion step of adhering the dye printing treatment liquid composition included in the composition set according to claim 11 to a cloth;
an ejection step of ejecting the ink jet ink composition included in the composition set according to claim 11 from a recording head so as to be adhered to an intermediate transfer medium; and
a transfer step of transferring the ink jet ink composition adhered to the intermediate transfer medium to the cloth to which the dye printing treatment liquid composition is adhered.
